(19) United States
(12) Patent Application Publication
(10) Pub. No.: US 2021/0122138 A1
(43) Pub. Date: Apr. 29, 2021

(54) DECORATIVE MATERIAL

(71) Applicant: Dai Nippon Printing Co., Ltd., Tokyo (JP)

(72) Inventors: Shiho Shibano, Tokyo (JP); Kazuhiro Suga, Tokyo (JP); Masaru Okamoto, Tokyo (JP); Shinji Iwata, Tokyo (JP); Yoshio Sukegawa, Tokyo (JP)

(73) Assignee: Dai Nippon Printing Co., Ltd., Tokyo (JP)

(21) Appl. No.: 17/041,718

(22) PCT Filed: Mar. 27, 2019
(86) PCT No.: PCT/JP2019/013271

§ 371 Date: Dec. 8, 2020

(30) Foreign Application Priority Data
Mar. 27, 2018 (JP) 2018-060608
Mar. 29, 2018 (JP) 2018-065847

(51) Int. Cl. B32B 3/30; B32B 33/00; B44C 5/04; B44C 5/06; E04F 13/08; B44F 9/04

(52) U.S. Cl. CPC B32B 3/30; B32B 33/00; B44C 5/04; B32B 2451/00; E04F 13/08; B44F 9/04; B32B 2307/412; B44C 5/06

(57) ABSTRACT

A decorative material including: a base material; and a textured pattern that is formed on one face of the base material, wherein a projection part that constitutes the textured pattern has at least one first slope and a second slope, one end of the first slope and one end of the second slope being linked to each other to form an apex of the projection part, the apex constituting a ridgeline, and the textured pattern is such that an inclination formed by the first slope and a plane of a sheet is smaller than an inclination formed by the second slope and the plane of a sheet.

### TECHNICAL FIELD

The present invention relates to a decorative material.

### BACKGROUND ART

There are many designs expressed on decorative materials, examples of which include, as Patent Literatures 1 to 3, a pattern of so-called stone grain which imitate and express cleavage planes of stone on a surface of the decorative material, and a textured pattern having a shape of a wall face with trace of a float by a plasterer using cement, plaster etc.

### PRIOR ART LITERATURE

### Patent Literature

[Patent Literature 1] JP S61-100595 U
[Patent Literature 2] JP 2003-211816 A
[Patent Literature 3] JP H8-52849 A

### SUMMARY OF INVENTION

### Problem to be Solved by Invention

It is demanded by the field of decorative materials that a decorative material manifesting a higher value-added tactile sense and external appearance of a design is provided in view of diversified preferences in recent years, and of demands for the real more than the past, and new visual and tactile surface aspects.

An object of the present invention is to provide a decorative material having a structure that makes it possible to give texture different from the conventional, to improve value added.

### Means for Solving Problem

The inventors of the present invention researched conventional decorative materials imitating recesses and projections on surfaces of cleavage planes of stones, and on surfaces in the form of wall faces by plasterers using cement, plaster etc. (with trace of a float etc.), and as a result found that there are almost no gradations in heights of textured shapes due to, for example, only two gradations of height and lowness, only one kind of inclinations even if there are slopes, etc. Based on this findings, the present invention was completed as embodying an aspect of a pattern which is visually and tactilely different from the conventional. Hereinafter the present invention will be described.

One aspect is a decorative material that includes a textured pattern formed on a surface thereof, the decorative material comprising: a base material; and the textured pattern, which is formed on one face of the base material, wherein a projection part that constitutes the textured pattern has at least one first slope and a second slope, one end of the first slope and one end of the second slope being linked to each other to form an apex of the projection part, the apex constituting a ridgeline, and the textured pattern is such that an inclination formed by the first slope and a plane of a sheet is smaller than an inclination formed by the second slope and the plane of a sheet.

Surface roughness of the first slope in a portion of the ridgeline may be larger than surface roughness of another first slope in a portion of a thalweg of a recess part, the thalweg being adjacent to the ridgeline.

A design layer may be further laminated onto the base material.

A transparent protective layer may be further layered on the base material or the design layer.

The design layer may have a stone grain-design.

The ridgeline may constitute a pattern like trace of a float according to a form of extending the ridgeline.

The ridgeline may constitute a stone grain-pattern according to a form of extending the ridgeline.

A plurality of protrusions may be aligned on at least either one of the first slope and the second slope.

### Effect of Invention

The present invention makes it possible to realize a decorative material having a textured pattern of diversified gradations in height compared to the conventional which expresses an external appearance of a design visually and tactilely different from the conventional.

### BRIEF DESCRIPTION OF DRAWINGS

FIG. 1 is a partially enlarged plan view showing a surface of a decorative material 10.

FIG. 2 is a partial cross-sectional view of the decorative material 10.

FIG. 3 is a partially enlarged view of FIG. 2.

FIG. 4 explanatorily shows θ₁ and θ₂ that are formed of a first slope and a second slope which constitute a textured pattern of a decorative material, on the textured pattern.

FIG. 5 is an explanatory plan view showing the relationship of the surface roughness between a ridgeline portion and a thalweg portion.

FIG. 6 is an explanatory cross-sectional view showing the relationship of the surface roughness between the ridgeline portion and the thalweg portion.

FIG. 7 explanatorily shows an example of measurement of θ₁, θ₂, Ra₁ and Ra₂.

FIG. 8 is a cross-sectional view of a decorative material 20.

FIG. 9 is a partial perspective view of a decorative material 30.

FIG. 10 is a plan view of a decorative material 40.

FIG. 11 is a partial perspective view of the decorative material 40.

FIG. 12 is a partially enlarged plan view showing a surface of a decorative material 50.

FIG. 13 is a cross-sectional view of the decorative material 50.

FIG. 14 is partially enlarged view of FIG. 13.

FIG. 15 is a plan view of a decorative material 60.

FIG. 16 is a partial cross-sectional view of the decorative material 60.

FIG. 17 explanatorily shows a scene where recesses and projections are formed on a die with laser.

FIG. 18 is a partial plan view of an embossed plate for making the decorative material 40 which is an example of an embossed plate.

FIG. 19 explanatorily shows a layer structure of a decorative material 10′.

FIG. 20 explanatorily shows a layer structure of a decorative material 10″.

### EMBODIMENTS TO CARRY OUT INVENTION

Hereinafter each embodiment will be described based on drawings. The present invention is not limited to these embodiments. The following drawings may show changed or exaggerated sizes and proportions of members for understandability, and portions unnecessary for the description, and repeatedly appearing signs may be omitted therefrom for visibility.

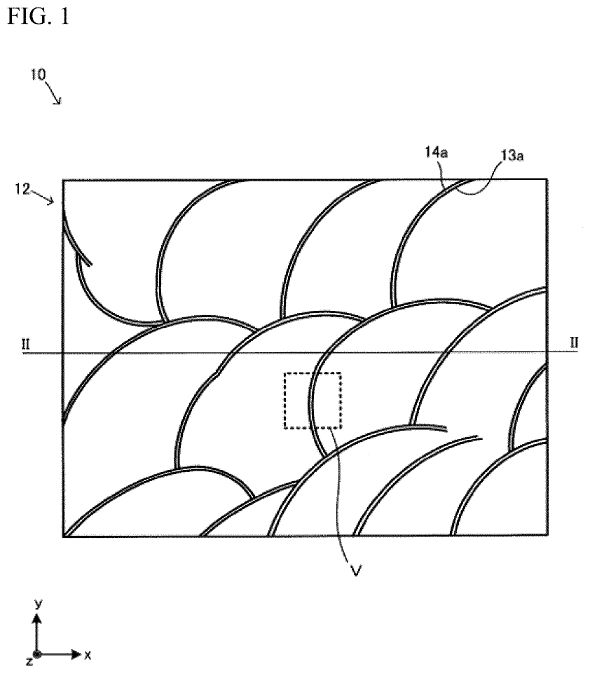

FIG. 1 is a partially enlarged plan view of a decorative material 10 according to the first embodiment on the textured pattern side. FIG. 1 also shows the arrows (x, y and z) indicating directions, that is, a coordinate system for convenience. Here, the direction xy is any direction in the plane of the decorative material 10, and the direction z is a thickness direction thereof, that is, a direction of the normal line of any direction in the plane (plane xy). Thus, FIG. 1 shows the decorative material 10 viewed in the direction z (direction of the normal line) on the textured pattern side.

As can be seen in FIG. 1, the decorative material 10 according to the present embodiment is patterned after a textured surface by wall plastering processed by a plasterer with a trowel etc. using cement, plaster, wall clay, etc.

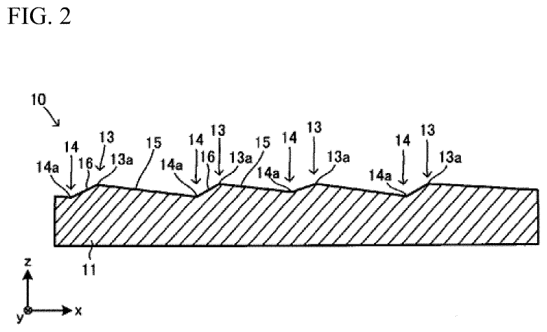

FIG. 2 shows a cross section in the thickness direction of the decorative material 10 taken along the line II-II in FIG. 1 (that is, a cross section taken along one plane in parallel to the plane zx). FIG. 2 shows a cross section taken by cutting a textured shape on a base material 11 in a straight line so as to cross ridgelines 13a that are formed of the apexes of projection parts 13. Such a cross section may be referred to as a main cross section.

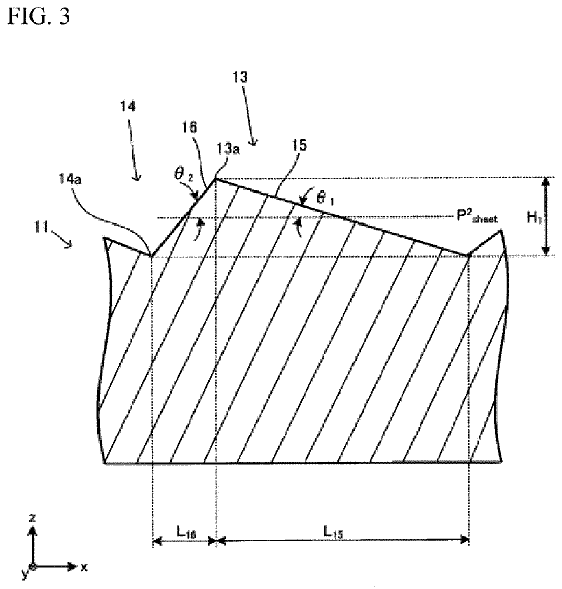

FIG. 3 shows a partially enlarged view of FIG. 2 which is focused on an area around one of the ridgelines 13a that is formed of the apex of one of the projection parts 13, and a thalweg 14a that is formed of the bottom of one recess part 14.

As can be seen in FIGS. 1 to 3, the decorative material 10 according to the present embodiment has the textured shape formed of the repeatedly disposed projection parts 13 and recess parts 14 on a surface thereof, and expresses a three-dimensional textured pattern like trace of a float by a plasterer, using the ridgelines 13a formed of the apexes of the projection parts 13 and the thalwegs 14a formed of the bottoms of the recess parts 14.

Specifically, the decorative material 10 has the base material 11, and a textured pattern that is formed of the projection parts 13 and the recess parts 14 on one surface of the base material 11. Hereinafter each structure will be described in detail.

The base material 11 constitutes a member having functions of supporting the textured pattern, and giving the decorative material 10 strength. The base material 11 may be in any form of a film, a sheet, or a plate. Base materials are generally referred to as films, sheets, and plates in ascending order of thickness. In the present embodiment, such difference based on the thickness of base materials is not an essential or important matter. Therefore, even if any term of a film, a sheet and a plate is read as another thereamong according to circumstances in the present description, the present invention never changes essentially, and claims never change interpretively.

The base material 11 has only to have the function same as that of conventionally known decorative materials, and thus, is not particularly limited. Examples of materials that can be usually used as the base material include polyolefin resins such as polyethylene, polypropylene, olefinic thermoplastic elastomers, and ionomers, acrylic resins such as polymethyl methacrylate, and polybutyl methacrylate, thermoplastic polyester resins such as polyethylene terephthalate, and polybutylene terephthalate, thermoplastic resins such as thermoplastic urethane resins, vinyl chloride resins, ABS resins (acrylonitrile-butadiene-styrene copolymers), and styrene resins, thermosetting resins such as melamine resins, unsaturated polyester resins, two-liquid curable urethane resins, and epoxy resins, and ionizing radiation curable resins that are radical-polymerizable acrylate or cation-polymerizable epoxy monomers or prepolymers, and are cured by ionizing radiation (such as an ultraviolet ray and an electron beam). When made from a resin, the base material may be colored by any known colorant. Other than the foregoing, paper, a nonwoven fabric, a metal, wood, or the like can be suitably laminated on any of the foregoing resin materials, to be also used in the form of a sheet, a plate, a 3D object, etc.

As the base material 11, composites (that is, thermosetting resin decorative materials, FRP, etc.) can be also used: the composites are obtained by impregnating a thermosetting resin such as melamine resins, phenolic resins, urethane resins, epoxy resins, unsaturated polyester resins, and diallyl phthalate resins with a fibrous sheet such as paper, and nonwoven fabrics, woven fabrics, and knit fabrics which are made of fibers of synthetic resins or glass, and curing the resin.

The base material has a thickness not particularly limited. For example, the base material can be used as having a thickness of approximately 20 μm to 1000 μm when being in the form of a sheet or a film, and can be used as having a thickness of approximately 1 mm to 20 mm when being in the form of a plate.

As can be seen in FIGS. 2 and 3, the textured pattern is formed of the repeatedly disposed projection parts 13 and recess parts 14.

Each of the projection parts 13 is formed by linking one end of each first slope 15 and one end of each second slope 16 at their apexes. The apexes constitute the ridgelines 13a. Each of the recess parts 14 is formed by linking the other end of the first slope 15 and the other end of the second slope 16 at their bottom portions. The bottom portions constitute the thalwegs 14a. Thereby, the projection parts 13 and the recess parts 14 are alternately disposed repeatedly, and the ridgelines 13a and the thalwegs 14a are alternately disposed repeatedly.

These ridgelines 13a and thalwegs 14a extend in any direction in the plane of the sheet as having given forms, which brings about an aspect having a desired pattern. In the present embodiment, as in FIG. 1, the ridgelines 13a and the thalwegs 14a extend to form a pattern like trace of a float by a plasterer.

Here, each of the first slopes 15 has an inclination θ₁ to any direction in a plane of the sheet P_{Sheet} (P²_{Sheet} shown in FIG. 3) as shown in FIG. 3, that is, any direction in parallel to the plane xy or to an assumed plane in parallel to the plane xy in FIGS. 2 and 3; and each of the second slopes 16 has an inclination θ₂ to any direction in parallel to any direction in the plane of the sheet P_{Sheet} as shown in FIG. 3. In FIG. 3, a cross section in any direction in the plane of the sheet is indicated by a dotted line extending in parallel to the direction x. Hereinafter an angle formed by the plane of the sheet P_{Sheet} and any of the first slopes 15 will be referred to as the inclination θ₁ of the first slope 15, or the inclination θ₁ in a shortened form. Also, an angle formed by the plane of the sheet P_{Sheet} and any of the second slopes 16 will be referred to as the inclination θ₂ of the first slope 16, or the inclination θ₂ in a shortened form. Further, the inclination θ₁ and the inclination θ₂ may be generally referred to as the inclinations, or the inclinations θ₁ and θ₂.

Here, “plane of the sheet P_{Sheet}” means a typical plane in any direction extending (spreading) in the plane when the decorative material is broadly viewed as a whole. In the case of a normal decorative material, a face obtained by smoothing an envelope of a surface of a textured pattern by the least squares method or the like is often a plane. In this case, such a plane obtained by smoothing an envelope, and any plane in parallel thereto each correspond to the plane of the sheet. When a face (back face) of the decorative material on the opposite side of the textured pattern is a smooth plane as in FIG. 3, this smoothed face opposite to the textured pattern of the decorative material, and any face in parallel thereto can be each the plane of the sheet.

When being a nonplane that is typically a curved face, a face is obtained by further flattening the curved face obtained by once smoothing the envelope, or by once smoothing the face opposite to the textured pattern, by the least squares method or the like. The obtained face is defined as the plane of the sheet.

Here, a plane of the sheet which crosses both the first slope 15 and the second slope 16 is selected as the plane of the sheet P_{Sheet}, which is the basis of measurement for defining the inclinations. Among them, a plane close to the ridgeline 13a can be selected as the plane of the sheet P_{Sheet}, which is the basis of measurement for defining the inclinations θ₁ and θ₂, since the difference between the first slopes 15 and the second slopes 16 in inclination affects visual and tactile senses most in the vicinity of the ridgelines 13a (apexes). In view of this point, the plane of the sheet P_{Sheet} to be the basis of measurement for defining the inclinations is selected and the inclinations θ₁ and θ₂ are obtained as the following (1) to (6).

(1)

First, a slope having a shorter distance Lₛₕₒᵣₜ (=min (L₁₅ and L₁₆)) out of distances L₁₅ and L₁₆ extending in any direction in the plane of the sheet (corresponding to the lengths of the orthogonal projections on the plane of the sheet P_{Sheet} in the inclining direction (direction x in FIG. 3)) is selected from the first slope 15 and the second slope 16 of a particular projection part 13 to be measured for the inclinations θ₁ and θ₂. Here, min (a and b) means that a smaller numeral value is selected out of two numeral values of a and b. In the case in FIG. 3,

Lₛₕₒᵣₜ=min(L₁₅ and L₁₆)=L₁₆

and thus, the second slope 16 is selected.
(2)

Next, the relationship between L_{Short} and 4/3 mm (=1.33333 . . . mm) in magnitude is clarified. In view of the measurement accuracy of general-purpose measurement equipment, and of a threshold when the difference is visually and tactilely detected, 1.3 mm is used without any problem concerning significant figures of 413 mm in actual measurement.

(3)

Based on the cleared relationship of the magnitude, a particular plane of the sheet P²_{Sheet} that crosses both the first slope 15 and the second slope 16 as shown in FIG. 3 is selected, which is specifically carried out as follows.

(3-1)

In the case where Lₛₕₒᵣₜ is larger than 4/3 mm (≈1.3):

a plane of the sheet which crosses both the first slope 15 and the second slope 16 and is away from the ridgeline 13a as a starting point by 1 mm in distance in any direction in the plane of the sheet (in the direction x in FIG. 3) is defined as the particular plane of the sheet P²_{Sheet}.

(3-2)

In the case where Lₛₕₒᵣₜ is at most 4/3 mm (≈1.3):
a plane of the sheet which crosses both the first slope 15 and the second slope 16 in a case where (¼)×Lₛₕₒᵣₜ<distance thereof from the ridgeline 13a as the starting point in any direction in the plane of the sheet (in the direction x in FIG. 3)≤(¾)×Lₛₕₒᵣₜ, that is, when the distance thereof from the ridgeline in any direction in the plane of the sheet is (¼)×L_{Short t} to (¾)×L_{Short} is defined as the particular plane of the sheet P²_{Sheet}.
   (4)

A triangle is obtained by making a triangular prism defined by the first slope 15, the second slope 16, and the particular plane of the sheet P²_{Sheet} cross a plane orthogonal to the triangular prism which is on the main cross section of the ridgeline 13a (in FIG. 3, the plane zx, or any face in parallel to the plane zx).

(5)

An interior angle formed by the base of the triangle, which corresponds to the particular plane of the sheet P²_{Sheet}, and a side thereof corresponding to the first slope 15 is defined as the inclination θ₁ of the first slope 15. Similarly, an interior angle formed by the base, of the triangle, which corresponds to the particular plane of the sheet P²_{Sheet}, and a side thereof corresponding to the second slope 16 is defined as the inclination θ₂ of the second slope 16.

(5-1)

When the first slope 15 and the second slope 16 are planes as in FIGS. 2 and 3 (straight lines on the main cross section), and the ridgeline 13a is a straight line (not shown), the plane of the sheet P_{Sheet} and the inclinations θ₁ and θ₂ are as described above.

(5-2)

Rather, it is often the case with actual textured patterns that at least one of the first slope 15 and the second slope 16 is at least partially not a plane (not a straight line on the main cross section as shown in FIG. 3). In such a case of a nonplane, the following is considered.

At this time, when any of the first slope 15 and the second slope 16 has minute recesses and projections on a surface thereof to be a rough face, a face is obtained by smoothing the rough face by a suitable means such as the least squares method. In this case, a face obtained by smoothing the first slope 15 is referred to as a smoothed first slope 15S, and a face obtained by smoothing the second slope 16 is referred to as a smoothed first slope 16S. The following is further considered according to characteristics of these smoothed first slope 15S and smoothed second slope 16S.

(5-2-1)

When the smoothed first slope 15S or the smoothed first slope 16S is a plane, the inclination θ₁ or θ₂ of such a smoothed slope 15S or 16S is obtained by the same method as in the foregoing case where the slopes are planes.

(5-2-2)

When any of the smoothed first slope 15S and the smoothed first slope 16S is not a plane, for example, is a curved face, the following is carried out.

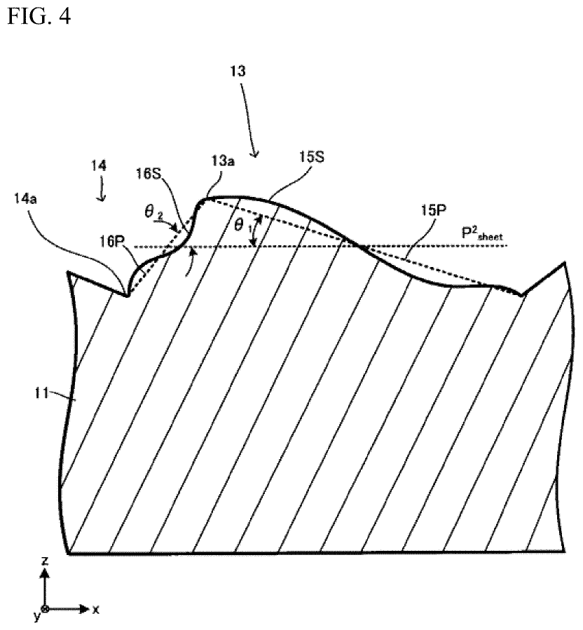

(5-2-2a) Concerning the smoothed first slope 15S or the smoothed second slope 16S, which is not a plane, as in FIG. 4, (point (apex) corresponding to) the ridgeline 13a and (point corresponding to) the thalweg 14a are linked, and a plane orthogonal to the main cross section is obtained. This corresponds to drawing a straight line linking the point corresponding to the ridgeline 13a, to the point corresponding to the thalweg 14a, on the main cross section as in FIG. 4. This obtained plane is referred to as a flattened smoothed first slope 15P, or a flattened smoothed second slope 16P.
(5-2-2b)

Thereafter the smoothed first slope 15S or the smoothed second slope 16S, which is not a plane, is replaced with the flattened smoothed first slope 15P or the flattened second smoothed slope 16P. Thereafter, the inclination θ₁ or θ₂ is obtained by the same method as in the foregoing case where the slopes are planes.

(6)

Next, the inclinations are determined by confirming whether or not there is distribution thereof in any direction in the plane of the sheet in the textured pattern. At this time, the following is considered according to characteristics of the inclinations in the textured pattern.

(6-1)

If the inclinations θ₁ of the first slopes 15 and the inclinations θ₂ of the second slopes 16 in the textured pattern are respectively the same in magnitude all over the plane of the sheet, the inclinations θ₁ and θ₂ at any point in the textured pattern may be defined as the inclinations θ₁ and θ₂ typical to the textured pattern.

(6-2)

If the inclinations θ₁ of the first slopes 15 and the inclinations θ₂ of the second slopes 16 in the textured pattern are respectively different between places on the plane of the sheet, the following is carried out.

(6-2a)

First, in the textured pattern, any portion of any one of the ridgelines 13a is selected. In the selected portion of the ridgeline, the inclinations θ₁ at any ten different points and inclinations θ₂ at any ten different points are obtained by the foregoing method. The average value of each of the inclinations θ₁ and θ₂ at any ten different points is defined as the inclinations θ₁ and θ₂ in the selected portion of the ridgeline.

(6-2b)

Next, in the textured pattern, any portion of another ridgeline is selected, and the inclinations θ₁ and θ₂ in the selected portion of the ridgeline are obtained using the average value of each of the inclinations θ₁ and θ₂ at any ten different points as the foregoing.

(6-2c)

The average value of each of the inclinations θ₁ and θ₂ at any ten different points can be regarded as converging when approximately 5 to 10 selected portions of each of plurality of the ridgelines are measured as described above so that dispersion of the average value of each of the inclinations θ₁ and θ₂ at any ten different points is determined to converge enough.

(6-2d)

Thereafter the inclinations θ₁ and θ₂ in the textured pattern are defined by values obtained by further averaging the average values of each of the inclinations θ₁ and θ₂ at any ten different points of the obtained number.

According to the foregoing (1) to (6), the particular plane of the sheet P²_{Sheet} to be the basis of measurement for defining the inclinations is selected, and the inclinations θ₁ and θ2 are obtained.

In the present embodiment, θ₁ is made to have the relationship such as to be smaller than θ₂. This makes it possible to obtain a decorative material having a richly varied external appearance closer to an actual trace of a float by a plasterer using cement, plaster, etc., such that it is avoided that limited gradations in the height of a textured pattern lead to almost no gradations like the conventional, and makes it possible to diminish unnaturalness in the external appearance. Even in view of a tactile sense, a decorative material different from the conventional is brought about in the same point of view.

Specifically, the inclinations θ₁ and θ₂ are not particularly limited in magnitude. The inclination θ₁ can be larger than 0° and at most 10°. The inclination θ₂ can be larger than 10° and at most 80°.

The larger the difference between the inclinations θ₁ and θ₂ is, the greater the effect is visually and tactilely, as the difference is not particularly limited though. The difference can be 5° to 70°.

Here, the interval between adjacent projection parts 13 (corresponding to the total length (L₁₅+L₁₆) of the orthogonal projections of the slopes 15 and 16 on the plane of the sheet P_{Sheet} (F²_{Sheet}) in FIG. 3) varies according to a pattern to be expressed, and thus there is no preferred range therefor in particular. An interval necessary for expression can be suitably set, and may be regular or may be irregular. The interval between the projection parts 13 can be within the range of 5 mm and 200 mm in view of reproducing an external appearance of a textured pattern like usual trace of a float, or of a usual stone grain-textured pattern.

The difference between the ridgeline 13a and the thalweg 14a in the thickness direction (direction z), which is shown by H₁ in FIG. 3, that is, the difference in the height (or a step) in the thickness direction is not particularly limited either, but is determined by the inclination θ₂, and the interval between the projection parts 13. Among them, generally, the difference in height can be made to be large in view of sufficient visibility, an external appearance of a design, and reproducibility of a tactile sense of a pattern formed on the decorative material. The difference in height can be however made to be small in view of easy formability of the textured pattern on the base material 11. That is, generally, the larger the difference in height is; the more difficult both production of a plate and faithful formation of the textured pattern on the base material are, and the thicker the minimum thickness of the base material on which the textured pattern can be formed is. Thus, the difference in height H₁ can be set in approximately 1 μm to 1000 μm in view of achieving both reproducibility of an external appearance of a design, and easy formability at the same time.

In the first embodiment, a style of fan finishing made by trace of a float by a plasterer is described as an example of the textured pattern. The present invention is not limited thereto. Any textured pattern having a surface of trace of a float can be also imitated: the textured pattern is formed on a finished surface of cement, plaster, wall clay, etc. by plastering, and is typically a so-called stucco-like, float finishing, or fan finishing textured pattern, or the like.

As described later, the following textured patterns can be also imitated: textured patterns of cleavage planes on surfaces of polycrystalline slates of granite etc., and textured patterns of fracture surfaces of various slates such as limestone, marble (crystalline limestone) and sandstone.

The textured pattern expressed in the present invention does not necessarily have the textured shape or structure same as that of a real textured pattern. In short, the present invention has only to be constructed so that an observer can perceive the external appearance of a design and/or tactile sense same as those/that of a textured pattern to be expressed.

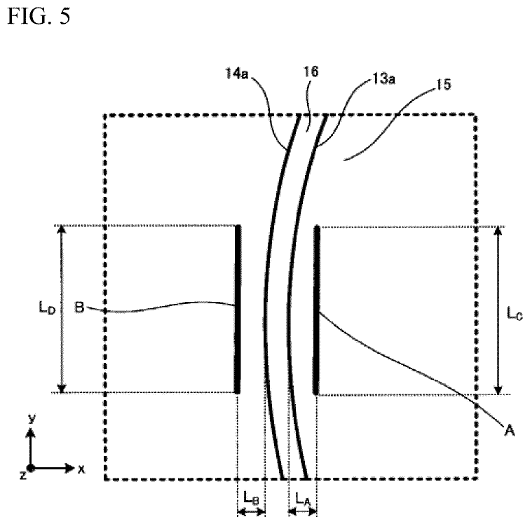

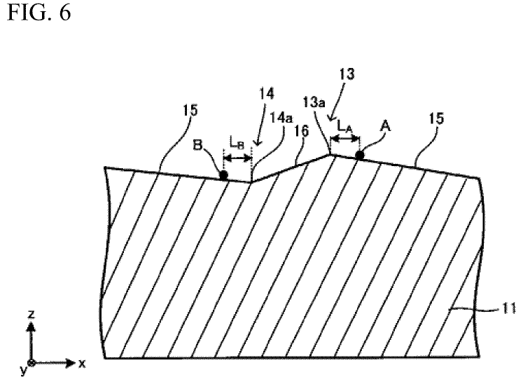

Further, the textured pattern can be formed as follows. FIGS. 5 and 6 show explanatory views. FIG. 5 is an enlarged plan view showing the area shown by V in FIG. 1, and FIG. 6 is a cross-sectional view from the same view point as FIG. 3.

As shown by A in FIGS. 5 and 6, surface roughness Ra in a range by a straight line having a given length in a direction along the ridgeline 13a on a portion of the first slope 15 in the textured pattern which is close to the ridgeline 13a is defined as Rₐ₁.

As shown by 13 in FIGS. 5 and 6, surface roughness Ra in a range by a straight line having a given length in a direction along the thalweg 14a adjacent to the ridgeline 13a close to A on another first slope 15 that is on a portion close to the thalweg 14a and is across the thalweg 14a with respect to the ridgeline 13a close to A in the textured pattern is defined as Rₐ₂.

Such Rₐ₁ and Rₐ₂ can be formed so that Rₐ₁ is larger than Ra₂. That is, the first slope 15 having a relatively gentle inclination is preferably formed so as to be relatively a rougher face on a ridgeline side thereof (vicinity of the ridgeline 13a) than on a valley side thereof (vicinity of the thalweg 14a). This leads to a decorative material not only visually different in view of sheen, but also tactilely different from the conventional. Particularly, an external appearance and a tactile sense of a textured pattern of a surface with trace of a float by plastering, or of a textured pattern of a cleavage plane on a surface of a polycrystalline slate can be effectively expressed in a rich variety of ways.

Here, the surface roughness Rₐ₁ and Rₐ₂ are measured as follows.

Similarly to the case of the inclination θ₁ of the first slope 15 and the inclination θ₂ of the second slope 16, places for the basis of measurement for the surface roughness Rₐ₁ and Rₐ₂ on a plane close to the ridgeline 13a are preferably selected since the difference in surface roughness affects visual and tactile senses most in the vicinity of the ridgelines 13a (apexes). Influence on visual and tactile senses is, however, slightly different between the inclination and the surface roughness. In view of this point, places where the surface roughness Rₐ₁ and Ra_{z} are measured, and measurement conditions for the surface roughness Rₐ₁ and Ra₂ are selected as follows. Here, surface roughness Ra (μm) means the arithmetic mean roughness in JIS B 0601-2001.

As described for the measurement of the inclinations θ₁ and θ₂, a shorter distance Lₛₕₒᵣₜ is obtained from the distances L₁₅ and L₁₆ of the first slope 15 and the second slope 16, which extend in any direction in the plane of the sheet (corresponding to the lengths of the orthogonal projections of the slopes on the plane P_{Sheet} (P²_{Sheet}) in the inclining direction shown in FIG. 3), on a portion where the surface roughness is to be measured.

When L_{Short} is longer than 4 mm, a value measured on a straight line having a measurement length L_{C} of 4 mm under the condition of cut-off value: 0.8 mm, in an area away from the ridgeline 13a by 2 mm in distance (L_{A}) on the first slope 15 is defined as the surface roughness Rₐ₁ of the first slope 15 on a portion close to the ridgeline 13a. A value measured on a straight line having a measurement length L_{D} of 4 mm under the condition of cut-off value: 0.8 mm, in an area away from the thalweg 14a by 2 mm in distance (L_{B}) on the first slope 15 is defined as the surface roughness Ra₂ of the first slope 15 on a portion close to the thalweg 14a.

When Lₛₕₒᵣₜ is at most 4 mm, a value measured on a straight line having a measurement length L_{C} of 4 mm under the condition of cut-off value: 0.8 mm, in an area away from the ridgeline 13a by at most (½)×L_{Short}, more preferably at most (¼)×L_{Short} in distance (L_{A}) on the first slope 15 is defined as the surface roughness Rₐ₁ of the first slope 15 on the portion close to the ridgeline 13a.

A value measured on a straight line having a measurement length L_{D} of 4 mm under the condition of cut-off value: 0.8 mm, in an area away from the thalweg 14a by at most (½)×L_{Short}, more preferably at most (¼)×L_{Short} by distance (L_{B}) on the first slope 15 is defined as the surface roughness Ra₂ of the first slope 15 on the portion close to the thalweg 14a.

Specifically, Rₐ₁ and Rₐ₂ are not particularly limited in magnitude. Rₐ₁ can be 0.02 μm to 20 μm. Ra₂ can be 0.005 μM to 5 μm.

The larger the difference between Rₐ₁ and Ra₂ is, the greater the effect is visually and tactilely, as the difference is not particularly limited though. The difference can be at least 0.02 μm, and may be at least 0.5 μm, and further may be at most 5 μm.

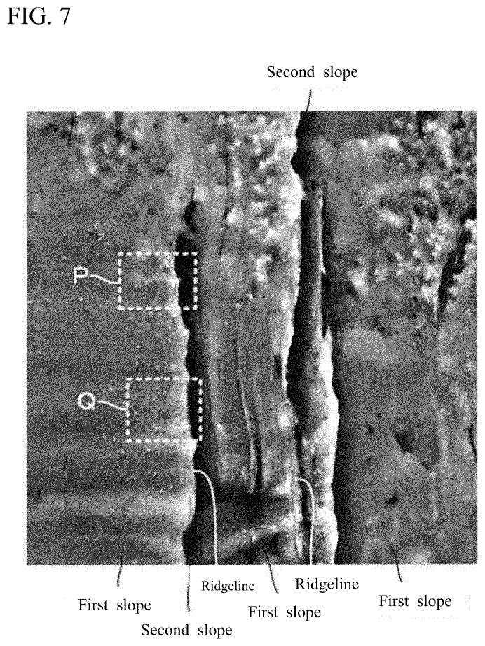

As one example, the inclination θ₁ of the first slope of the made decorative material, and the inclination θ₂ of the second slope thereof were measured. Further, the surface roughness Rₐ₁ of a ridgeline portion, and the surface roughness Ra₂ of a thalweg portion were measured. FIG. 7 shows a partially enlarged plan view of the decorative material to be measured, where portions surrounded by P and Q were measured.

### <Shape of Decorative Material>

A monolayer base material having a thickness of 300 μm, and formed of a white polyvinyl chloride sheet that contains an additive of a white pigment constituted of a titanium dioxide particle, and a 20 mass parts plasticizer was used as the decorative material produced for the measurement.

This is produced by forming a textured pattern having characteristics of a textured shape shown as the plan view of FIG. 7 and in Table 1, on a surface on one side by the foregoing method.

<Measurement of θ₁ and θ₂>

A 3D shape was inputted using a 3D measurement system (VR-3000 by KEYENCE CORPORATION), and θ₁ and θ₂ were measured according to the foregoing method.

<Measurement of Rₐ₁ and Ra₂>

A 3D shape was inputted using a 3D measurement system (VR-3000 by KEYENCE CORPORATION), and Rₐ₁ and Rₐ₂ were measured as described above.

### <Results>

The foregoing made it possible to obtain the results as in Table 1.

TABLE 1

| Portion to | Inclination (°) | | Surface roughness Ra (μm) | |
|---|---|---|---|---|
| be measured | θ₁ | θ₂ | Ra₁ | Ra₂ |
| P | 3.01 | 10.44 | 0.020 | 0.012 |
| Q | 4.87 | 26.52 | 0.038 | 0.018 |

The decorative material of such an aspect could be obtained. The foregoing led to the decorative material having texture visually and tactilely different from the conventional.

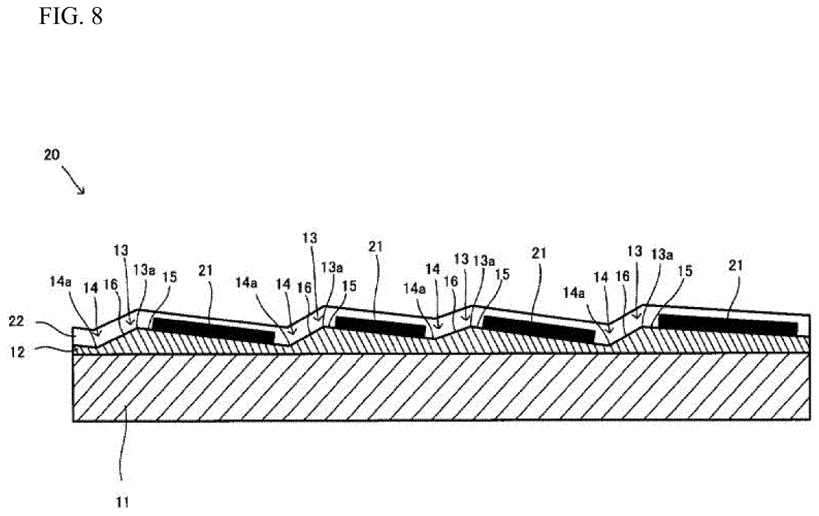

FIG. 8 explanatorily shows a decorative material 20 according to the second embodiment. FIG. 8 is viewed from the same view point as FIG. 2. Here, the same reference signs are added to the structures same as in the decorative material 10 according to the first embodiment, and description of those structures is omitted.

In the decorative material 20, a pattern formation layer 12, design layers 21, and a transparent protective layer 22 are further laminated on the structure of the decorative material 10.

The pattern formation layer 12 is laminated on one face of the base material 11, and provides the decorative material with a pattern. In the present embodiment, the pattern formation layer 12 has a given patterned shape to form a textured pattern. When the base material 11 itself has formability for textured patterns (receptivity for textured patterns), the embodiment of directly forming the textured pattern on the base material 11 as described above can be employed without the pattern formation layer 12 disposed independently from the base material 11.

Designs are drawn on the design layers 21. In the present embodiment, the design layers 21 are laminated on the first slopes 15.

Specific designs can be arranged on the design layers 21 without any limitations: the designs encompass various patterns such as wood grain patterns, patterns like trace of a float which is typically, for example, stucco, and fan finishing trace of a float, and patterns of stone grain which is typically a cleavage plane or a fracture face of slate of granite, marble, sandstone, etc., color patterns, photographs, paintings, drawings, and geometrical patterns, clothes that are typically various fabrics and nonwoven fabrics, leathers, artificial leathers, creped resins, etc. For example, if a pattern of given expression (in the present embodiment, a pattern like trace of a float) is formed by the pattern formation layer 12, a design according to this pattern can be employed. At this time, the design may be according to, or may be different from recesses and projections on the pattern formation layer 12.

For example, such designs on the design layers 21 can be formed by ink layers that are made by printing such as gravure printing, silk screening, and ink jet printing.

An ink constituting the design layers 21 has only to be suitably selected among known ones according to color tones of the design, and required physical properties. For example, as a binder resin for the ink, one of an acrylic resin, a vinyl chloride-vinyl acetate copolymer, a cellulose resin, an urethane resin, a polyester resin, etc. can be used alone, or two or more of them can be used in combination.

Examples of a colorant (such as a pigment and a die) that can be used as a colorant include white colorants such as titanium white and flowers of zinc, black colorants such as carbon black (black ink), iron black, and azomethine azo pigments, yellow colorants such as chrome yellow, titanium yellow, polyazo yellow, isoindolinone yellow, and nickel azo complexes, red colorants such as red iron oxide, cadmium red, polyazo red, and quinacridone red, blue colorants such as ultramarine blue, cobalt blue, and phthalocyanine blue, metallic pigments made from flakelike foil of aluminum, brass, etc., and pearl pigments made from flakelike foil of titanium dioxide coated mica, basic lead carbonate, etc.

Other than the foregoing, a suitable amount of various additives such as a plasticizer, a surfactant, a heat stabilizer, a UV absorber, a light stabilizer, and a lubricant can be added if necessary.

The transparent protective layer 22 protects the design layers 21 and the pattern formation layer 12 from pollution, scratches, etc., and can be formed of a transparent resin, transparent glass, or the like.

When a transparent resin is used, examples thereof include thermoplastic resins, and cured resins.

When a durability performance of a surface, such as anti-pollution and abrasion resistance can be secured enough for the aimed purpose only by the base material 11, the pattern formation layer 12, and the design layers 21, the transparent protective layer 22 can be omitted.

Examples of the thermoplastic resins include acrylic resins such as polymethyl (meth)acrylate and polyethyl (meth)acrylate, polyolefin resins such as polypropylene and polyethylene, fluorine resins such as polyvinyl fluoride and polyvinylidene difluoride, polyester resins such as polyethylene terephthalate (PET), polybutylene terephthalate (PBT), and polyethylene naphthalate (PEN), polycarbonate resins, vinyl chloride resins, acrylonitrile-butadiene-styrene resins (ABS resins), and acrylonitrile-styrene-acrylic acid ester resins. “(Meth)acryl” means acryl or methacryl.

A layer formed of any of the cured resins is obtained by curing a curable resin composition. The curable resin composition contains a curable resin. Examples of the curable resin composition include thermosetting resin compositions containing a thermosetting resin, and ionizing radiation curable resin compositions containing an ionizing radiation curable resin.

Examples of the thermosetting resin include unsaturated polyester resins, polyurethane resins (including two-liquid curable polyurethane), epoxy resins, aminoalkyd resins, phenolic resins, urea resins, diallyl phthalate resins, melamine resins, guanamine resins, melamine-urea condensation resins, fluorine resins, and polysiloxane resins. The thermosetting resin composition may contain any component to be involved in the curing reaction of the thermosetting resin, such as a catalyst and a curing agent (including a crosslinking agent, a polymerization initiator, and a polymerization promotor) if necessary. A crosslinking polymerization reaction is issued from an ionizing radiation curable resin by irradiation with ionizing radiation, to change the ionizing radiation curable resin to have a 3D polymer structure. Ionizing radiation is an electromagnetic wave or a charged particle beam which has an energy quantum that makes it possible to polymerize or crosslink molecules, and which encompasses an ultraviolet ray (UV) and an electron beam (EB), and in addition, an electromagnetic wave such as a X-ray and a γ-ray, and a charged particle beam such as an α-ray and an ion beam. An ultraviolet ray (UV) or an electron beam (EB) is usually used. Among ionizing radiation curable resins, an electron beam curable resin can be solventless, does not require a photopolymerization initiator, and offers stable curing characteristics.

Examples of an ionizing radiation curable resin that can be used include compositions containing at least one of a monomer, an oligomer, a prepolymer, etc. having in its molecule a polymerizable unsaturated bond of a (meth)acryloyl group etc., an epoxy group, etc. which can be crosslinked by irradiation with ionizing radiation.

The transparent protective layer 22 has a thickness not particularly limited. The thickness can be 0.1 μm to 20 μm. The transparent protective layer 22 having a thickness within the foregoing range can be well-balanced since a less thickness leads to high durability against bending etc. but low abrasion resistance, and a more thickness leads to high abrasion resistance, that is, high resistance against scratches but low resistance against deformation such as bending which causes cracks etc. For example, the thickness can be 1 μm to 10 μm.

The decorative material 20 as described above also has the same effect as the decorative material 10 particularly since including the relationship such that the inclination θ₁ is smaller than the inclination θ₂.

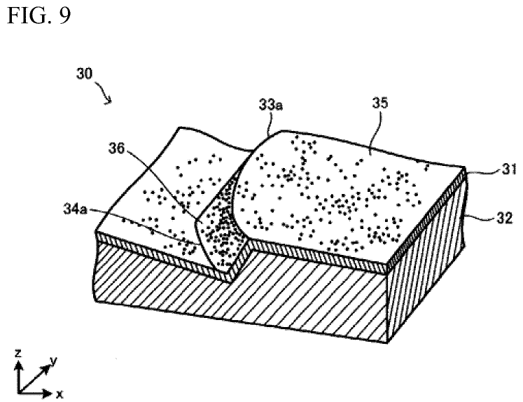

FIG. 9 explanatorily shows a decorative material 30 according to the third embodiment. FIG. 9 is a perspective view taken by cutting a part of an area around one ridgeline 33a and one thalweg 34a from the decorative material 30.

The decorative material 30 according to the present embodiment has a pattern formation layer 32 having a stone grain-pattern. This pattern formation layer 32 also expresses stone grain in the extending direction of the ridgeline 33a and the thalweg 34a, like the pattern formation layer 12.

This pattern formation layer 32 also has a first slope 35 and a second slope 36 to form the ridgeline 33a and the thalweg 34a, and has a textured shape such that the inclination of the first slope 35 is smaller than that of the second slope 36, like the pattern formation layer 12. The relationship between the surface roughness in the vicinity of the ridgeline 33a, and that in the vicinity of the thalweg 34a may be also such that the surface roughness in the vicinity of the ridgeline is formed so as to be larger than that in the vicinity of the thalweg, like the pattern formation layer.

This makes it possible to obtain a decorative material having a richly varied external appearance closer to an actual stone grain and thus being less unnatural, such that expression of almost no gradations is avoided, differently from the conventional. Even in view of a tactile sense, a decorative material different from the conventional is brought about.

The decorative material 30 uses the pattern formation layer 32 also as the base material. The decorative material 30 includes a design layer 31 that expresses an external appearance of a design of a wall face using colored lime plaster made by lights and shades of a colored ink on one face of a monolayer of the pattern formation layer 32, and omits any transparent protective layer, in structure.

In the present embodiment, for a pattern of the design layer, a stone grain pattern that has an external appearance of a design fitted to a textured pattern like trace of a float, and is formed of colored ink layers where color tones having gradations in shades are distributed on the plane is employed. In the present embodiment, the textured pattern of the pattern formation layer 32 can be different from the design of the design layer.

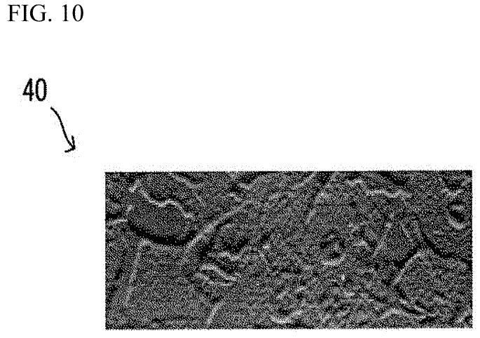

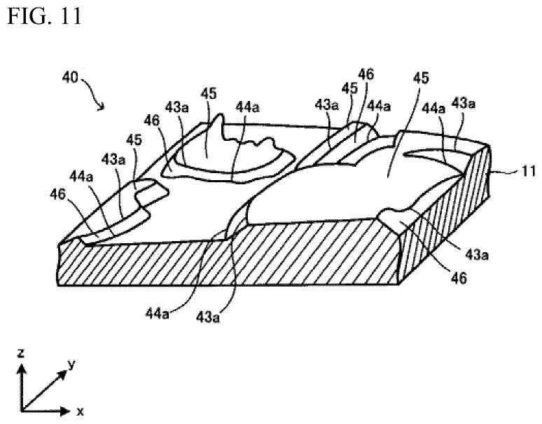

FIGS. 10 and 11 explanatorily show a decorative material 40 according to the fourth embodiment. FIG. 10 is a plan view of the decorative material 40 which corresponds to FIG. 1, and FIG. 11 is a partial perspective view showing the decorative material 40.

As can be seen in FIGS. 10 and 11, the decorative material 40 according to the present embodiment is an example of the base material 11 having a stone grain-textured pattern on one face thereof. This textured pattern expresses stone grain in the extending direction of a ridgeline 43a and a thalweg 44a thereon, like trace of a float on the textured pattern of the decorative material 10.

This textured pattern of the decorative material 40 also has a first slope 45 and a second slope 46 to form the ridgeline 43a and the thalweg 44a, and has a textured shape such that the inclination of the first slope 45 is smaller than that of the second slope 46, like the textured pattern of the decorative material 10. The relationship between the surface roughness in the vicinity of the ridgeline 43a, and that in the vicinity of the thalweg 44a may be also such that the surface roughness in the vicinity of the ridgeline is formed so as to be larger than that in the vicinity of the thalweg, like the textured pattern of the decorative material 10.

In the present embodiment, the textured pattern is also formed on one face of the base material 11. The decorative material 40 includes a design layer not shown which expresses an external appearance of a design of a wall face using colored lime plaster made by lights and shades of a colored ink on one face of this textured pattern, and omits any transparent protective layer, in structure.

This makes it possible to obtain a decorative material having a richly varied external appearance closer to an actual stone grain, such that expression of almost no gradations as the conventional is avoided, differently from the conventional. Even in view of a tactile sense, a decorative material different from the conventional is brought about.

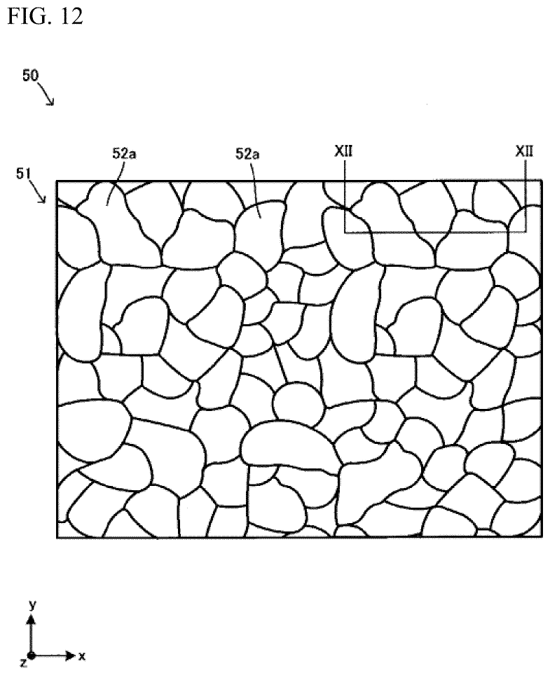

FIG. 12 is a partially enlarged plan view of a decorative material 50 according to the fifth embodiment on the textured pattern side. As can be seen in FIG. 12, the decorative material 50 according to the present embodiment is a stone-grain decorative material that is patterned after recesses and projections on a surface like a cleavage plane of granite.

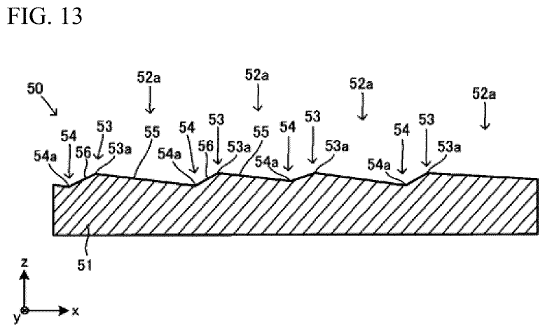

FIG. 13 shows a cross section of the decorative material 50 in the thickness direction taken along the line XII-XII in FIG. 12 (that is, a cross section taken along one face in parallel to the plane zx). FIG. 13 corresponds to FIG. 2, and shows a cross section taken by cutting a textured shape on a base material 51 in a straight line so as to cross ridgelines 53a that are formed of the apexes of projection parts 53, which is a main cross section. FIG. 13 is a schematic view, and does not show the cross section XII-XII precisely.

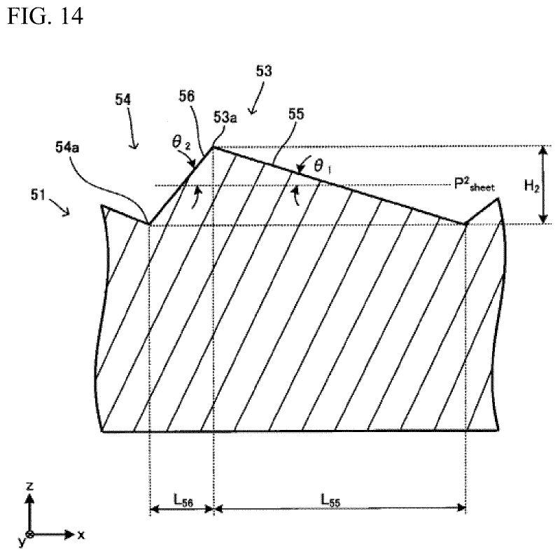

FIG. 14 shows a partially enlarged view of FIG. 13 which is focused on an area around one of the ridgelines 53a that is formed of the apex of one of the projection parts 53, and a thalweg 54a that is formed of the bottom of one recess part 54, and corresponds to FIG. 3.

As can be seen in FIGS. 12 to 14, the decorative material 50 according to the present embodiment includes a plurality of enclosed areas 52a that are aligned in any direction of the plane xy in a plan view, and has a textured shape of the repeatedly disposed projection parts 53 and recess parts 54 on a surface thereof. The decorative material 50 includes the ridgelines 53a that are formed of the apexes of the projection parts 53, and the thalwegs 54a that are formed of the bottoms of the recess parts 54. The ridgelines 53a form the contours of the areas 52a. This leads to expression of a three-dimensional textured pattern like a cleavage plane of granite.

Specifically, the decorative material 50 has the base material 51, and a textured pattern that is formed of the projection parts 53 and the recess parts 54 on one surface of the base material 51.

The base material 51 can be considered the same as the base material 11.

As can be seen in FIGS. 13 and 14, the projection parts 53 and the recess parts 54 are repeatedly disposed to form the textured pattern.

Each of the projection parts 53 is formed by linking one end of each first slope 55 and one end of each second slope 56 at their apexes. The apexes constitute the ridgelines 53a. Each of the recess parts 54 is formed by linking the other end of the first slope 15 and the other end of the second slope 56 at their bottom portion. The bottom portions constitute the thalwegs 54a. Thereby, the projection parts 53 and the recess parts 54 are alternately disposed repeatedly, and the ridgelines 53a and the thalwegs 54a are alternately disposed repeatedly.

These extending ridgelines 53a and thalwegs 54a form the enclosed areas 52a as in FIG. 12. In the present embodiment, a plurality of the areas 52a are included in the plane xy, which leads to a stone grain-pattern, especially a pattern like a cleavage plane of granite.

Here, the inclinations θ₁ and θ₂ shown in FIG. 14 can be considered the same as in the foregoing description for the decorative material 10.

In the present embodiment, θ₁ is also made to have the relationship such as to be smaller than θ₂. This makes it possible to obtain a decorative material having a richly varied external appearance closer to an actual cleavage plane of granite and being less unnatural, such that it is avoided that limited gradations in the height of a textured shape lead to almost no gradations like the conventional. Even in view of a tactile sense, a decorative material different from the conventional is brought about in the same point of view.

Here, the interval between adjacent areas 52a varies according to stone grain to be expressed, and thus there is no preferred range therefor in particular. An interval necessary for expression can be suitably set, and may be regular or may be irregular. The interval between adjacent areas 52a can be within the range of 5 mm and 200 mm in view of reproducing an external appearance of a usual stone grain-textured pattern.

The difference between the ridgeline 53a and the thalweg 54a in the thickness direction (direction z), which is shown by H₂ in FIG. 14, that is, the difference in the height (or a step) in the thickness direction is not particularly limited either, but is determined by the inclination θ₂, and the interval between the projection parts 53. Among them, generally, the difference in height can be made to be large in view of sufficient visibility, an external appearance of a design, and reproducibility of a tactile sense of a pattern formed on the decorative material. The difference in height is however made to be small in view of easy formability of the textured pattern on the base material 51. That is, generally, the larger the difference in height is, the more difficult both production of a plate and faithful formation of the textured pattern on the base material are, and the thicker the minimum thickness of the base material on which the textured pattern can be formed is. Thus, this difference can be set in approximately 1 μm to 1000 μm in view of achieving both reproducibility of an external appearance of a design, and easy formability at the same time.

The textured pattern expressed here does not necessarily have the textured shape or structure same as a real textured pattern. In short, the textured pattern has only to be formed so that an observer can perceive the same external appearance of a design and/or tactile sense same as those/that of a textured pattern to be expressed.

The surface roughness Rₐ₁ and Rₐ₂, and the relationship therebetween, which were described with reference to FIGS. 5 and 6, are also applicable to the decorative material 50 according to the present embodiment, the drawings thereabout is omitted though.

The decorative material 50 according to the present embodiment may be also provided with the pattern formation layer, the design layer, and the transparent protective layer, as employing the embodiment described with reference to FIG. 8.

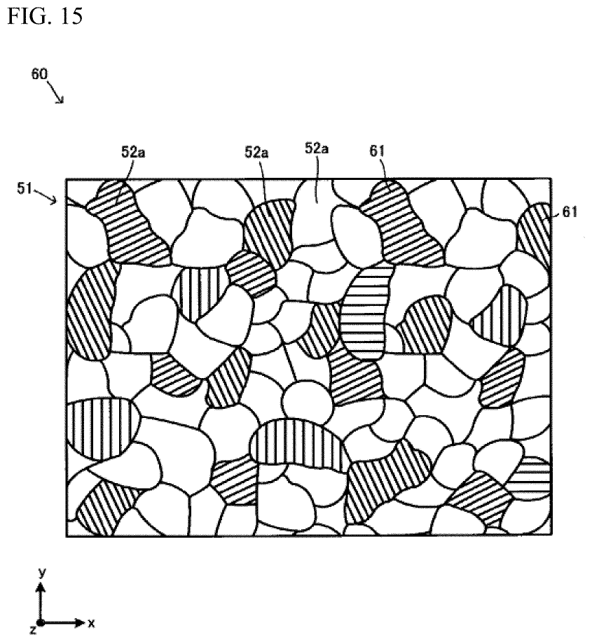

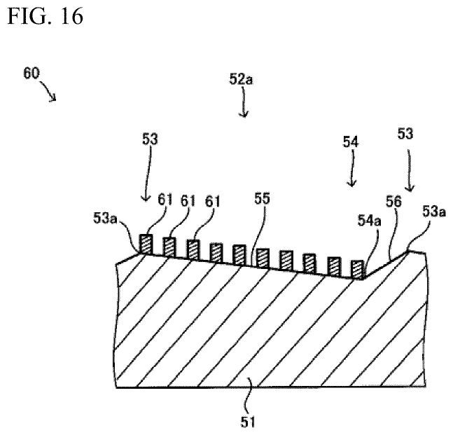

FIGS. 15 and 16 explanatorily show a decorative material 60 according to the sixth embodiment. FIG. 6 is a plan view corresponding to FIG. 12. FIG. 16 is a cross-sectional view that is focused on one of the areas 52a that includes protrusions 61.

As can be seen in FIGS. 15 and 16, a plurality of the protrusions 61 like parallel lines are aligned on a part of the areas 52a of the decorative material 60 according to the present embodiment. Here, the same reference signs as in the decorative material 50 are added to the portions that can be considered the same as in the decorative material 50.

A plurality of the protrusions 61 each have a given cross section (rectangular cross section in the present embodiment), extend in one direction in some of the areas 52a, and are aligned at intervals in a direction different from the extending direction. In the present embodiment, the protrusions 61 are formed on the first slope 55 having a gentle inclination. The present invention is not limited thereto. The protrusions 61 may be arranged only on the second slope 56, or in both directions of the first slope 55 and the second slope 56.

The present embodiment shows an example such that some of the areas 52a where the protrusions 61 are aligned, and the rest of the areas 52a where no protrusion 61 is aligned coexist. The present invention is not limited thereto. The protrusions 61 may be arranged on all the areas 52a.

The protrusions 61 arranged on a plurality of the areas 52a do not each necessarily have the same height, pitch, and width, and the extending directions thereof are not necessarily the same. The protrusions 61 can be formed to have a height, pitch, width, or extending direction, at least one of which is different between each area 52a.

The decorative material 60 as described above can also offer further different visual and tactile senses in addition to the foregoing effect.

Next, one example of a method for producing a decorative material will be described using the decorative material 10 as an example. The method for producing the decorative material 10 is not limited to this example though.

The producing method described as follows includes the steps of creating a block copy image, making a plate, and forming a textured pattern.

In the step of creating a block copy image, a pattern in a plan view which is to be expressed on the surface of the base material 11 is obtained as density (lights and shades) of the image, to be used as a block copy image. The block copy image is preferably in the form of digital data. Thus, when the block copy image is not in the form of digital data, digital data that is formed by aligning pixels in a two-dimensional coordinate space (x, y), and assigning a density value unique to each pixel to each pixel is obtained by using a means of reading an original itself or a photograph of the original of stone, a surface finished with, for example, trace of a float by a plasterer, etc., with a scanner, and subjecting the original or the photograph to AD conversion. When the pattern is designed in the form of digital data first of all using CAD or the like, this digital data can be used.

Then, the block copy image is obtained as digital data.

In this step of creating a block copy image, based on the obtained continuous gradation image of the density of the pattern, a linear binary image pattern is created on the continuous gradation image of the density, and is arranged so that a part of pixels in the continuous gradation image of the density constitute ridgelines or thalwegs, and the ridgelines and thalwegs in the block copy image are obtained as digital data.

Specifically, for example, the following method is used. The present invention is not limited to a decorative material obtained by the following method though.

That is, the rate of change in the density of the image according to the increase of a position coordinate in each direction on the plane is calculated. A pixel at the maximum, where the density of the image peaks and starts to decrease as the coordinate increases, is defined as a pixel of the ridgeline 13a. In addition, a pixel at the minimum, where the density of the image hits bottom and starts to increase as the coordinate increases, is defined as a pixel of the thalweg 14a.

Such processing is carried out on each pixel in the continuous gradation image of the density, which leads to obtainment of image data having lines corresponding to the ridgelines 13a and the thalwegs 14a in the continuous gradation image of the density.

The image data has such a feature that: in a direction orthogonal to the line corresponding to the ridgeline 13a in the two-dimensional coordinate space, the density value is increasing as being measured in a place gradually closer to a point corresponding to the ridgeline 13a; the density value peaks at the point corresponding to the ridgeline 13a; and the density value is decreasing as being measured in a place gradually further away from the point corresponding to the ridgeline 13a.

The image data has such a feature that: in a direction orthogonal to the line corresponding to the thalweg 14a in the two-dimensional coordinate space, the density value is decreasing as being measured in a place gradually closer to a point corresponding to the thalweg 14a; the density value hits bottom at the point corresponding to the thalweg 14a; and the density value is increasing as being measured in a place gradually further away from the point corresponding to the thalweg 14a.

Next, concerning the inclination θ₁ of the first slope 15 and the inclination θ₂ of the second slope 16, formed by the second slope 16, in the textured pattern, of which a decorative material to be produced is required, a design value of “area ratio r of an area where the relationship such that θ₁ is smaller than θ₂ is satisfied, to the total area of the decorative material” is set into a desired value.

Next, the difference between the front and the back of the ridgeline 13a in density gradient in the continuous gradation image of the density, which is processed as described above, is calculated, and the difference between both areas holding the ridgeline 13a in mean density gradient is calculated.

Specifically, the density value at each position coordinate is obtained as the coordinate is gradually increasing by a given distance in the direction orthogonal to the ridgeline 13a toward the ridgeline 13a, and the mean density gradient along the increasing way and distance is calculated. When the thalweg 14a and the ridgeline 13a are adjacent to each other, such a given distance is from this adjacent thalweg 14a to this adjacent ridgeline 13a. In addition, the density value at each position coordinate is obtained as the coordinate is increasing along the foregoing way from the ridgeline 13a toward the thalweg 14a adjacent to this ridgeline 13a, and the mean density gradient along the increasing way and distance is calculated.

Next, the mean density gradient on each side of a particular pixel on a particular ridgeline 13a along the foregoing way is compared. Such processing is carried out on each pixel on each ridgeline 13a.

Next, an integral value S is obtained by integrating a length of (a) portion(s) of all the ridgelines 13a which satisfy(ies) the condition that the mean density gradient on each side of each pixel on the portion(s) be different, all over the area of the continuous gradation image of the density.

Next, the integral value S, and the area ratio σ, which is set as a design value, are compared. It is then confirmed whether the difference between the integral value S and the area ratio σ converges to a preset allowable level e or less, that is, whether

|(S−σ)/σ|≤e

is satisfied or not.

If the difference converges to the preset allowable level e or less, the creation of the block copy image is ended. If the difference does not converge to the preset allowable level e or less, the density of each pixel in the continuous gradation image of the density is retouched so that the difference converges to the preset allowable level e or less.

Line segments of the ridgelines created as described above correspond to the ridgelines on the decorative material. On the basis of these ridgelines, an area under a thalweg that is adjacent to a ridgeline, and is on one side of this ridgeline which is selected by a creator of the block copy image is assigned to the first slope, and an area under a thalweg that is adjacent to the ridgeline, and is on the other side of the ridgeline is assigned to the second slope.

In the step of making a plate, an embossed plate (molding die for decorative materials) is made: the embossed plate has, on a surface thereof, a textured pattern of inverse recesses and projections to a textured pattern (height and lowness) that is made by converting a shade image (lights and shades of the density values) in the pattern in a plan view based on the block copy image, into cell depths.

Specifically, the step of producing the textured pattern includes the following procedures (A) to (E).

### [(A) Step of Creating Shade Gradation Block Copy Image]

Lights and shades image data corresponding to the textured pattern in FIG. 1, which is obtained in the foregoing, is obtained. This lights and shades image data is also referred to as textured pattern image data.

### [(B) Step of Preparing Metal Roll]

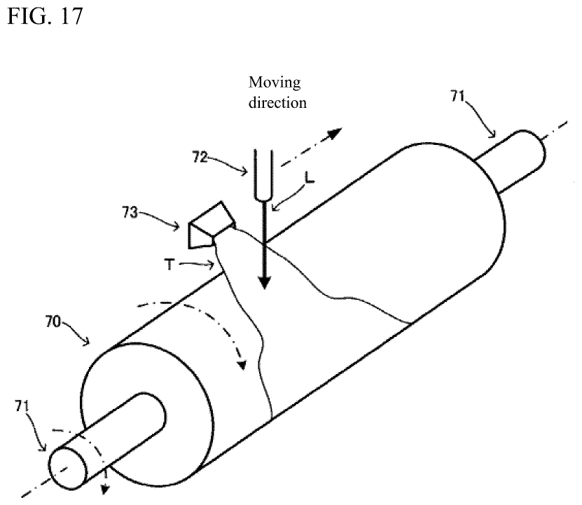

At the same time as the step (A), a metal roll 70 for chasing embossed plates as shown in FIG. 17 is prepared. The metal roll 70 is obtained by plating a copper layer on a surface of a hollow iron cylinder that has a rotation driving axis (shaft) 71 at both end portions in the axis direction. The surface of the metal roll 70 is polished by a whetstone to be a rough face, to be treated so that specular reflection of laser light for chasing is prevented from deteriorating chasing efficiency.

[(C) Step of Chasing with Laser Light]

The surface of the metal roll 70, which is prepared in the step (B), is chased using a laser light direct chaser based on the textured pattern image data, which is created in the step (A), as schematically shown in FIG. 17. This leads to, on the surface of the metal roll 70, formation of the textured shape of inverse recesses and projections to the textured pattern on the surface of the decorative material as shown in FIG. 1 (having the relationship such that portions corresponding to projections on the decorative material are recesses on the face of the embossed plate), which has the same shape as the textured pattern on the surface of the decorative material as shown in FIG. 1 in a plan view.

Therefore, a shape that the textured pattern on the embossed plate is to have is an aspect such that the relationship of recesses and projections on the textured pattern of the decorative material is reversed, and can be considered the same as the decorative material.

The metal roll 70 is driven by an electric motor via the rotation driving axis 71, to be rotated around the rotation driving axis 71 as the central axis. All over the surface of the metal roll 70 is scanned with fiber laser light L that is emitted from a laser head 72 under the conditions of: oscillation wavelength: 1024 nm; laser spot diameter: 10 μm; and power: 600 W. At this time, the laser light is switched ON and OFF (switched between irradiation and non-irradiation) according to the density values of the textured pattern image data, which is created in the step (A). Vaporization of metal leads to formation of a recess part having a depth of 10 μm at an irradiated position irradiated with the laser light once. Scanning of the surface of the metal roll is repeated with such laser light ten times. The irradiation with the laser light is carried out in a state where liquid for chasing T is sprayed from an exhaust port for liquid for chasing 73 onto an area irradiated with the laser light which is on the surface of the metal roll 70 in order to prevent powder converted from the vaporized metal from remaining or adhering to the surface of the metal roll 70.

At this time, for example, for a position coordinate at which the density of the image corresponds to 50 μm in cell depth on the textured pattern image data, the irradiation with the laser light is controlled so as to be switched ON only for the first 5 times in the total ten times of the scanning, and to be switched OFF for the rest five times,

When the density of the image in the textured pattern image data which corresponds to each position coordinate on the metal roll 70 is converted into a cell depth to be chased, first, a distribution range (maximum cell depth−minimum cell depth, which corresponds to the maximum difference in height on the surface of the decorative material to be obtained after embossing) of desired cell depths (as a design objective) of the embossed plate is determined. Thereafter a chasing control program of the laser light direct chaser is set so that a distribution range of the density of the image in the textured pattern image data corresponds to the distribution range of the cell depths.

Specifically, it is programmed to make the maximum density correspond to the maximum cell depth (maximum chasing amount), and to make the minimum density correspond to the minimum cell depth (minimum chasing amount), which makes a portion where the density of the image is higher in the textured pattern image data correspond to a portion where the cell depth is deeper.

Such scanning with the laser light is completed, to form a desired textured shape on the surface of the metal roll 70.

### [(D) Electropolishing Step]

After the liquid for chasing is, washed away, electropolishing is carried out, to remove the residue of the metal adhered to the surface of the metal roll 70.

### [(E) Step of Chrome Plating]

After the step (D), a chromium layer having a thickness of 10 μm is formed on the surface of the metal roll by plating.

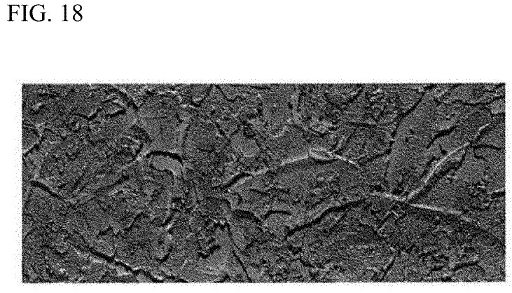

This makes it possible to obtain a plate (die for molding decorative materials, the embossed plate in the present embodiment) including a textured shape that is formed of inversed recesses and projections to the textured pattern formed on the surface of the base material 11. FIG. 18 shows a partial plan view of the embossed plate obtained as described above. This embossed plate is for molding the decorative material 40.

Next, in the step of forming a textured pattern, the decorative material 10 is obtained by embossing the base material 11 using the made plate (embossed plate). The embossing can be suitably carried out by any known method without any particular limitations. Examples of typical embossing methods include the following.

A resin sheet made from a thermoplastic resin such as polyolefin resins is used as the base material. This base material is heated and softened. The embossed plate is pressed onto a surface of the base material, to form the textured pattern on the surface of the embossed plate, on the surface of the resin sheet. Then, the resin sheet is cooled and cured, and then the textured pattern thereon is fixed. Thereafter the resin sheet, on which the textured pattern is formed, is removed from the embossed plate.

Here, a variety of embossing methods such as the following (a) to (e) will be further described.

(a) A resin sheet that is to be the base material is heated and softened. The embossed plate is pressed onto, and embosses the resin sheet.

(b) A resin sheet (base material) that becomes a surface sheet by heat and pressure when the embossed plate is pressed, and a resin sheet (second base material) that is to be a base sheet are thermal-bonded, to be embossed by the doubling embossing method of carrying out embossing and laminating at the same time.

(c) A resin sheet (base material) that is to be a surface sheet is subjected to melt extrusion via a T-die, and made to be in contact with the top of a cylindrical embossed plate that also functions as a cooling roller, to be embossed at the same time when the surface sheet is formed. At this time, a resin sheet (second base material) that is to be a base sheet, and is inserted on the back face side of the surface sheet is further thermal-bonded, to be subjected to doubling embossing at the same time as the sheet formation.

(d) As disclosed in JP S57-87318 A and JP H7-32476 A, a surface of a cylindrical embossed plate is coated with an uncured liquid of an ionizing radiation curable resin. Further, the top of the surface is irradiated with ionizing radiation as a base sheet formed of a resin sheet etc. is laminated thereon, and the uncured liquid is cured to be a cured material. At this time, this cured material is adhered to the base sheet, and thereafter removed from the embossed plate, to constitute a base material that is formed of the base sheet and the cured material on the base sheet, which results in the embossed base material.

(e) Impregnated paper that is obtained by impregnating an uncured material of a thermosetting resin such as melamine resins with paper such as titanium paper is placed on a backing material such as core paper and plywood. A plurality of these placed layers are subjected to heat press molding to be laminated and integrated, and then a thermosetting resin decorative material is made. At this time, the embossed plate is inserted on the surface side of the impregnated paper, which results in a surface of the paper embossed at the same time as heat pressing when the thermosetting resin is impregnated and cured to constitute the decorative material.

A thermoplastic resin is typically used as the material of the base material used in the embossing methods (a) to (c), an ionizing radiation curable resin is typically used as the material of the base material used in the embossing method (d), and a thermosetting resin is typically used as the material of the base material used in the embossing method (e).

The decorative material 10 can be obtained as described above.

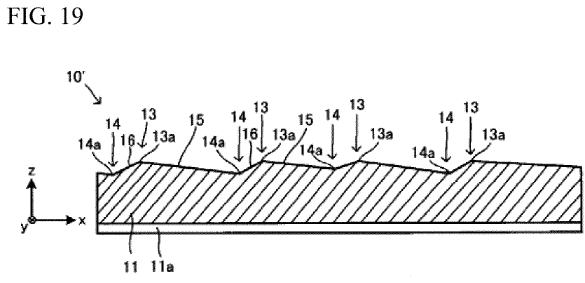

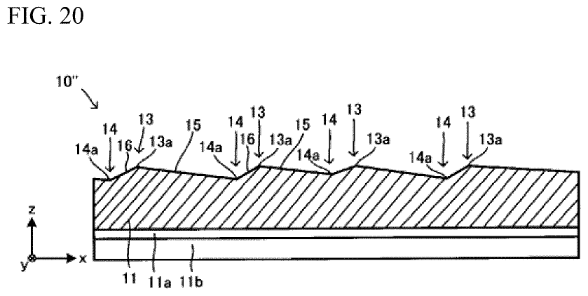

Next, modifications of the decorative material will be described. FIGS. 19 and 20 show layer structures. These modifications are based on the decorative material 10, but are applicable to the other foregoing decorative materials as well.

A decorative material 10′ has the structure in FIG. 19, such that a decorative layer 11a is formed on the back side of the base material 11. For making the decorative material 10′ having such a structure, for example, one can use a transparent resin sheet as the base material 11 so that the decorative layer 11a can be seen through the base material 11, print and form the decorative layer 11a on a face of the base material 11 which is to be on the back side of the base material 11, and thereafter heat and soften, and then embossing the base material 11 such that the embossed plate is pressed onto a face of the base material 11 which is to be on the surface side of the base material 11.

A decorative material 10″ having the structure in FIG. 20 is an example such that another base material 11b that is a base sheet is further laminated on a face of the decorative layer 11a which is on the opposite side to a side where the textured pattern is arranged, in addition to the structure in FIG. 19. For making the decorative material 10″ having such a structure, one can print and form the decorative layer 11a on a face of the base material 11b on the surface side of the base material 11b, which is formed of a nontransparent colored thermoplastic resin sheet that is to be the base sheet, and thereafter laminate this base sheet, and the base material 11 formed of a transparent thermoplastic resin sheet that is to be a surface sheet by thermal bonding, and at the same time emboss a desired textured pattern on the surface of the base material 11, by doubling embossing.

The use of the foregoing decorative material is not particularly limited, but examples thereof include interior materials for buildings such as walls, floors, and ceilings, exterior materials for buildings such as exterior walls, roofs, gates, walls, and fences, fittings such as doors, window frames, and door frames, facing materials for millwork such as crown moldings, skirting boards, and handrails, facing materials for housings of home appliances such as TV sets, and refrigerators, and of office equipment such as copying machines, facing materials for furniture such as chests of drawers, facing materials for containers such as boxes and resin bottles, interior and exterior materials for vehicles etc., and interior and exterior materials for vessels.

### DESCRIPTION OF REFERENCE SIGNS

10, 20, 30, 40, 50, 60 decorative material
11, 51 base material
12 pattern formation layer
13, 53 projection part
13a, 53a ridgeline
14, 54 recess part
14a, 54a thalweg

1. A decorative material that includes a textured pattern formed on a surface thereof, the decorative material comprising:
a base material; and
the textured pattern, which is formed on one face of the base material,
wherein a projection part that constitutes the textured pattern has at least one first slope and a second slope, one end of the first slope and one end of the second slope being linked to each other to form an apex of the projection part, the apex constituting a ridgeline, and
the textured pattern is such that an inclination formed by the first slope and a plane of a sheet is smaller than an inclination formed by the second slope and the plane of a sheet.

2. The decorative material according to claim 1, wherein
surface roughness of the first slope in a portion of the ridgeline is larger than surface roughness of another first slope in a portion of a thalweg of a recess part, the thalweg being adjacent to the ridgeline.

3. The decorative material according to claim 1, wherein a design layer is further laminated onto the base material.

4. The decorative material according to claim 1,
wherein a transparent protective layer is further layered on the base material or a design layer.

5. The decorative material according to claim 3, wherein the design layer has a stone grain-design.

6. The decorative material according to claim 1,
wherein the ridgeline constitutes a pattern like trace of a float according to a form of extending the ridgeline.

7. The decorative material according to claim 1,
wherein the ridgeline constitutes a stone grain-pattern according to a form of extending the ridgeline.

8. The decorative material according to claim 1,
wherein a plurality of protrusions are aligned on at least either one of the first slope and the second slope.
